(19) United States
(12) Patent Application Publication
(10) Pub. No.: US 2026/0116100 A1
(43) Pub. Date: Apr. 30, 2026

(54) PRINTING APPARATUS AND CLEANING METHOD FOR PRINTING APPARATUS

(71) Applicant: SEIKO EPSON CORPORATION, TOKYO (JP)

(72) Inventors: Keisuke SASAKI, Matsumoto-shi (JP); Kenichi FURUYA, SHIOJIRI-SHI (JP); Hidefumi MINEMURA, SHIOJIRI-SHI (JP); Narihiro OKI, MATSUMOTO-SHI (JP)

(21) Appl. No.: 19/372,833

(22) Filed: Oct. 29, 2025

(30) Foreign Application Priority Data
Oct. 29, 2024 (JP) 2024-189586

(51) Int. Cl. B41J 13/00; B08B 1/10; B08B 1/20; B08B 1/30; B41J 3/60; B41J 11/00; B41J 13/03; B41J 29/17

(52) U.S. Cl. CPC B41J 13/0045; B08B 1/10; B08B 1/20; B08B 1/30; B41J 3/60; B41J 11/0095; B41J 13/03; B41J 29/17

(57) ABSTRACT

A printing apparatus includes a conveyance path through which a medium is conveyed, a conveyance roller pair, a platen, a printhead, a inverting path that branches from the conveyance path at a position at a backward direction side of the conveyance roller pair in the conveyance path, and a control circuit configured to control drive of the conveyance roller pair, wherein the control circuit executes first control of causing the conveyance roller pair to convey the medium in a forward direction based on an execution of a cleaning mode, and then executes second control of causing the conveyance roller pair to convey the medium in a backward direction, causing the medium to merge with the conveyance path via the inverting path, and causing the conveyance roller pair to convey the medium in the forward direction.

The present application is based on, and claims priority from JP Application Serial Number 2024-189586, filed Oct. 29, 2024, the disclosure of which is hereby incorporated by reference herein in its entirety.

### BACKGROUND

### 1. Technical Field

The present disclosure relates to a printing apparatus and a cleaning method for a printing apparatus.

### 2. Related Art

As a printing apparatus in which dirt on a platen is wiped away, those described in JP-A-2021-130537 and JP-A-2009-234785 are known.

An inkjet recording apparatus disclosed in JP-A-2021-130537 causes a user to form a first fold and a second fold in a cleaning sheet and then conveys the cleaning sheet to thereby wipe away the dirt on the platen with the first fold and the second fold.

An inkjet printer disclosed in JP-A-2009-234785 includes a medium deformation unit that forms a downward convex portion bent so as to be convex downward in a part of a normal recording medium such as plain paper, and wipes away ink stain on the platen with the downward convex portion of the recording medium.

JP-A-2021-130537 and JP-A-2009-234785 are examples of the related art.

In the apparatus described in JP-A-2021-130537, the user needs to form the first fold and the second fold in the cleaning sheet, which causes a problem that such time and effort degrade the usability of the user, and in the apparatus described in JP-A-2009-234785, there is a problem that the inkjet printer grows in size due to the medium deformation unit for providing the downward convex portion to the recording medium.

### SUMMARY

A printing apparatus according to an aspect of the present disclosure includes a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction, and a controller configured to control drive of the conveyance roller, wherein the controller executes, based on reception of an execution of a cleaning mode of cleaning the conveyance path, first control of causing the medium to reach at least the support portion by causing the conveyance roller to convey the medium in the forward direction and then executes second control of merging the medium with the conveyance path via the inverting path by causing the conveyance roller to convey the medium in the backward direction, and causing the conveyance roller to convey the medium in the forward direction.

A printing apparatus according to an aspect of the present disclosure includes a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller, wherein the controller causes the conveyance roller to perform intermittent conveyance of the medium in a direction from the conveyance roller toward the printhead on the conveyance path based on reception of an execution of a cleaning mode of cleaning the conveyance path.

A printing apparatus according to an aspect of the present disclosure includes a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller and the printhead, wherein the controller causes, based on reception of an execution of a cleaning mode of cleaning the conveyance path, the conveyance roller to convey the medium in a direction from the conveyance roller toward the printhead on the conveyance path, and causes the printhead to eject the droplets to thereby print a pattern with the droplets on the medium.

A printing apparatus according to an aspect of the present disclosure includes a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller and the printhead, wherein the controller causes, based on reception of an execution of a cleaning mode of cleaning the conveyance path, the conveyance roller to perform intermittent conveyance of the medium in a direction from the conveyance roller toward the printhead on the conveyance path, and causes the printhead to eject the droplets to thereby print a pattern with the droplets on the medium.

A cleaning method for a printing apparatus according to an aspect of the present disclosure is a cleaning method for a printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction, the method including causing the medium to reach at least the support portion by conveying the medium in the forward direction and then merging the medium with the conveyance path via the inverting path by causing the conveyance roller to convey the medium in the backward direction, and causing the conveyance roller to convey the medium in the forward direction.

### BRIEF DESCRIPTION OF THE DRAWINGS

FIG. 1 is a perspective view showing a printing apparatus according to the present embodiment.

FIG. 2 is a perspective view showing the printing apparatus according to the present embodiment.

FIG. 3 is a cross-sectional view showing a schematic configuration of the printing apparatus along the line III-III in FIG. 2.

FIG. 4 is a perspective view showing a configuration of a platen of the printing apparatus according to the present embodiment.

FIG. 5 is a block diagram showing an electrical configuration of the printing apparatus according to the present embodiment.

FIG. 6 is a flowchart representing a method of cleaning the platen of the printing apparatus according to the present embodiment.

FIG. 7 is a flowchart according to Modified Example 1 of the cleaning method shown in FIG. 6.

FIG. 8 is a flowchart according to Modified Example 2 of the cleaning method shown in FIG. 6.

FIG. 9 is a diagram showing an example of conveyance parameters.

FIG. 10A is a diagram showing an example of printing.

FIG. 10B is a diagram showing an example of printing.

FIG. 10C is a diagram showing an example of printing.

FIG. 10D is a diagram showing an example of printing.

FIG. 10E is a diagram showing an example of printing.

### DESCRIPTION OF EMBODIMENTS

An embodiment of the present disclosure will hereinafter be described with reference to the drawings.

In the drawings, elements are drawn at different dimensional scales in some cases in order to make the elements eye-friendly.

In the drawings, for the sake of convenience of description, three axes, that is, an X axis, a Y axis, and a Z axis orthogonal to each other are illustrated, and a tip side of an arrow indicating an axial direction is referred to as a “positive side” and a base end side thereof is referred to as a “negative side”. Further, a direction parallel to the X axis is referred to as an “X-axis direction”, a direction parallel to the Y axis is referred to as a “Y-axis direction”, and a direction parallel to the Z axis is referred to as a “Z-axis direction”.

The X axis is an axis parallel to an installation surface of the printing apparatus 1, and corresponds to the width direction of the printing apparatus 1 and the width direction of the medium M. The Y axis is an axis parallel to the installation surface of the printing apparatus 1 and corresponds to the depth direction of the printing apparatus 1. The Z axis is an axis perpendicular to the installation surface of the printing apparatus 1 and corresponds to the height direction of the printing apparatus 1. In the printing apparatus 1, the negative side in the Y-axis direction is a front side, and the positive side in the Y-axis direction is a rear side. The positive side in the Z-axis direction is an upper side, and the negative side in the Z-axis direction is a lower side. Note that a region located at the front side is also referred to as a front portion, and a surface facing the front side is also referred to as a front surface. A region located at the rear side is also referred to as a rear portion, and a surface facing the rear side is also referred to as a back surface. A region located at the upper side is also referred to as an upper portion, and a surface facing upward is also referred to as an upper surface. Further, a region located at the lower side is also referred to as a lower portion, and a surface facing downward is also referred to as a lower surface.

### 1. Configuration of Printing Apparatus

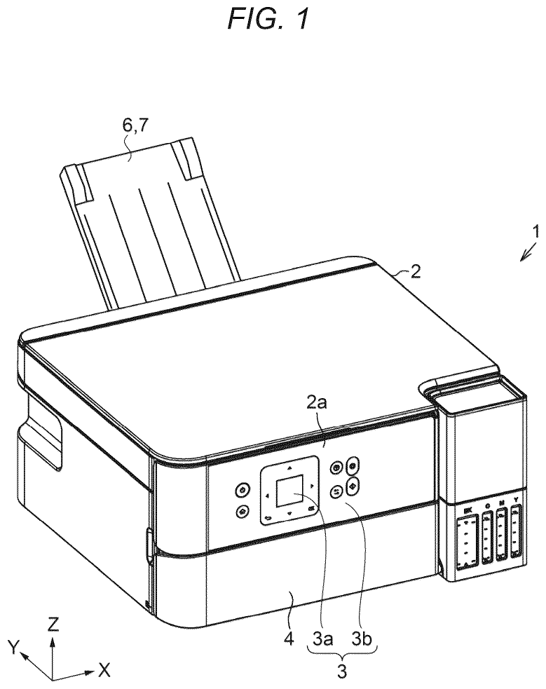

A configuration of a printing apparatus 1 according to the present embodiment will hereinafter be described with reference to FIGS. 1 to 4.

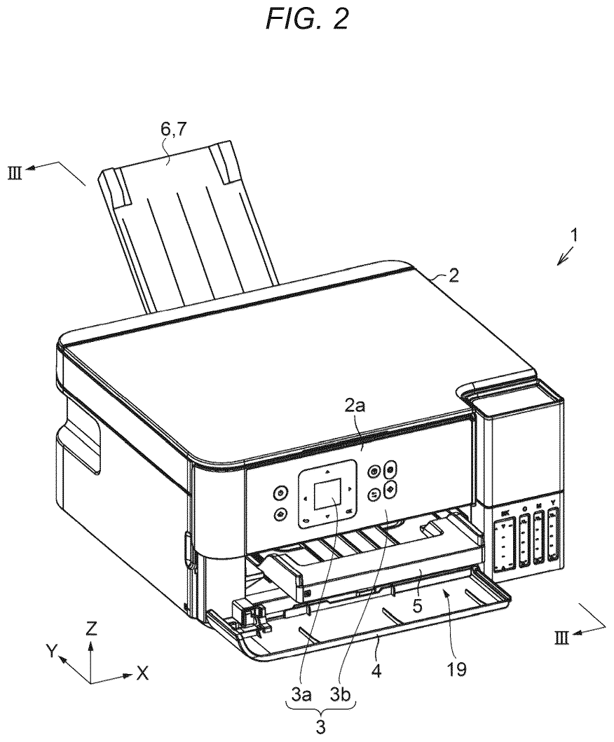

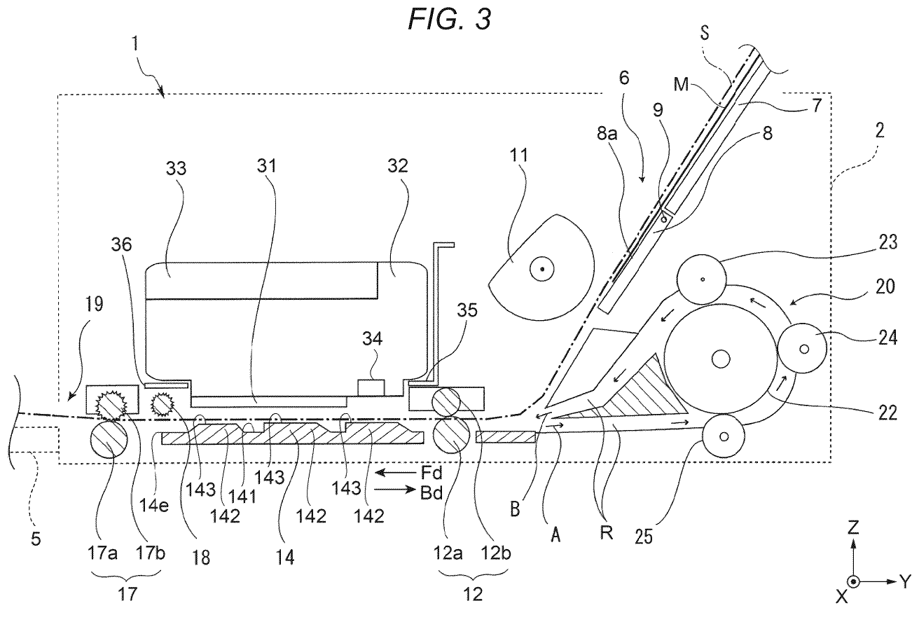

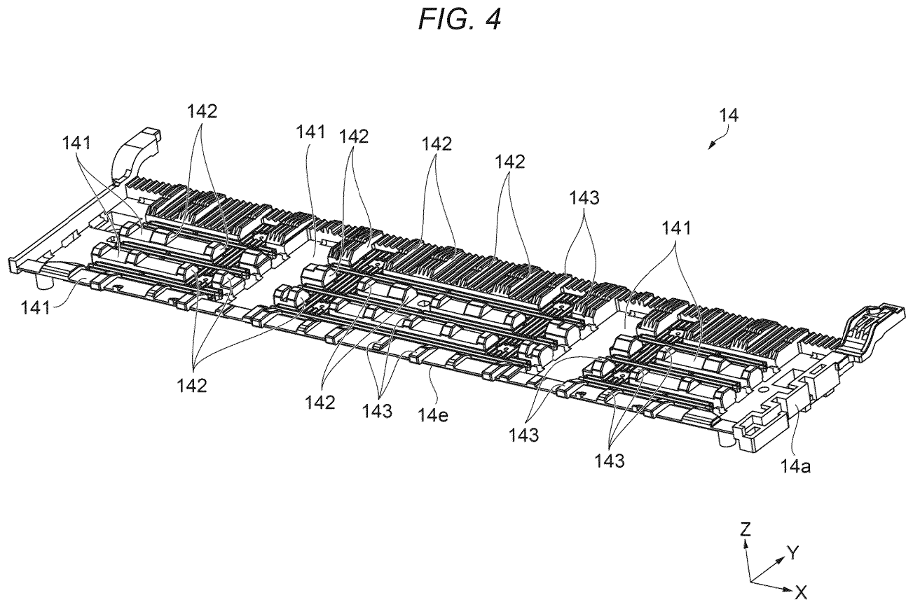

FIGS. 1 and 2 are perspective views of the printing apparatus 1. FIG. 3 is a cross-sectional view illustrating a schematic configuration of the printing apparatus 1 along the line III-III in FIG. 2. FIG. 4 is a perspective view illustrating a configuration of a platen 14 of the printing apparatus 1.

As illustrated in FIG. 1, the printing apparatus 1 is a printer of an inkjet type that performs printing by ejecting droplets onto a medium M based on image data such as characters and figures. The droplets are, for example, ink. The medium M is, for example, a paper.

The printing apparatus 1 includes a housing 2. The housing 2 is an exterior of the printing apparatus 1. The housing 2 includes a front surface 2a.

The printing apparatus 1 includes an operation panel 3. The operation panel 3 is provided to the front surface 2a. The operation panel 3 includes a display unit 3a and an input unit 3b. The display unit 3a is, for example, a liquid crystal panel, and the input unit 3b is configured with operation buttons. Note that the operation panel 3 may be a touch panel display or a voice user interface (VUI).

The printing apparatus 1 includes an openable cover 4. The openable cover 4 is provided to the front surface 2a. The openable cover 4 can be opened and closed with respect to the front surface 2a. The openable cover 4 is movable between a closed position shown in FIG. 1 and an open position shown in FIG. 2.

As illustrated in FIG. 2, the printing apparatus 1 includes a loading portion 5. The loading portion 5 is a paper discharge stacker on which the medium M having been printed is mounted. The loading portion 5 can be housed in the housing 2. The loading portion 5 is movable to the negative side in the Y-axis direction and the positive side in the Y-axis direction. The loading portion 5 protrudes frontward from the front surface 2a in a state where the openable cover 4 is disposed at the open position.

As illustrated in FIG. 3, a medium setting unit 6 in which a plurality of media M can be set is provided to the back surface of the printing apparatus 1. The medium setting unit 6 includes a paper feed tray 7 on which the media M are placed and a hopper 8. A leading end side of the medium M is supported by the support surface 8a of the hopper 8 to have an inclined posture. A trailing end side of the medium M that is not supported by the hopper 8 is supported by the paper feed tray 7 disposed upstream of the hopper 8 in the conveyance path S of the medium M. The conveyance path S of the medium M is indicated by a dashed-dotted line.

A feed roller 11 is disposed at a position facing the support surface 8a of the hopper 8. The hopper 8 is disposed so as to be swingable such that the support surface 8a of the hopper 8 advances toward and retracts from the feed roller 11 taking a pivot shaft 9 extending in the X-axis direction as an axis upstream in the conveyance path S of the medium M. The hopper 8 is pressed toward the feed roller 11 by a pressing member (not illustrated). The feed roller 11 feeds the medium M toward a printhead 31.

When the support surface 8a of the hopper 8 swings in a direction of approaching the feed roller 11, the medium M mounted the closest to the feed roller 11 out of the media M mounted on the hopper 8 comes into contact with the feed roller 11. When the feed roller 11 rotates, the medium M is picked up one by one and is then fed downstream in the conveyance path S.

The medium M fed from the upstream in the conveyance path S is conveyed to a printing position between the printhead 31 and the platen 14 by a conveyance roller pair 12 configured with a conveyance driving roller 12a and a conveyance driven roller 12b. The conveyance driving roller 12a is driven by a conveyance motor 51 described later. Note that in the present embodiment, the conveyance roller pair 12 is an example of a conveyance roller.

In the conveyance path S, when a direction from the conveyance roller pair 12 toward the printhead 31 is defined as a forward direction Fd and a direction opposite to the forward direction Fd is defined as a backward direction Bd, the printhead 31 is disposed at the forward direction Fd side of the conveyance roller pair 12.

The printhead 31 is a printer head of an inkjet type that ejects the ink onto the medium M being conveyed to print an image such as a character or a figure. The printhead 31 is mounted on a carriage 32. An ink cartridge 33 for supplying the ink to the printhead 31 can be mounted on the carriage 32.

The carriage 32 is configured to be able to receive power from a drive source (not illustrated) to reciprocate in a direction crossing the conveyance direction of the medium M, in other words, the X-axis direction which is the width direction of the medium M.

The carriage 32 is supported by a first guide rail 35 and a second guide rail 36 extending in the X-axis direction. The carriage 32 is driven by a carriage motor 52 described later. The carriage 32 moves along the first guide rail 35 and the second guide rail 36.

The first guide rail 35 is disposed upstream of the printhead 31, and the second guide rail 36 is disposed downstream of the printhead 31. The first guide rail 35 and the second guide rail 36 are supported by the housing 2 at both ends in the X-axis direction.

A sensor 34 is mounted on the carriage 32.

The sensor 34 is an optical reflective sensor including a light emitting unit and a light receiving unit. The sensor 34 functions as a medium detector 34a and a medium dirt detector 34b described later.

The medium detector 34a receives, with the light receiving unit, reflected light which is light emitted from the light emitting unit toward the medium M and is then reflected by the medium M, and detects presence or absence of the medium M based on a detection amount of the reflected light received by the light receiving unit.

The medium dirt detector 34b detects presence or absence of dirt on the medium M and a degree of the dirt based on the detection amount of the reflected light received by the light receiving unit. Note that the sensor 34 may be configured with a plurality of sensors.

The platen 14 that supports the medium M is disposed below the printhead 31. The platen 14 forms a part of the conveyance path S on which the medium M is conveyed, and the medium M is conveyed in the forward direction Fd or the backward direction Bd on the conveyance path S while being in sliding contact with the platen 14. In the present embodiment, the platen 14 is an example of a support portion.

A gap which makes it possible to convey the medium M is formed between a lower surface of the printhead 31 and an upper surface of the platen 14. When performing printing, the printhead 31 ejects the ink toward the medium M which is conveyed while being supported by the platen 14.

A discharge roller pair 17 including a discharge driving roller 17a and a discharge driven roller 17b is disposed downstream of the printhead 31. A discharge section 19 is disposed at the front side of the printing apparatus 1, which is downstream of the discharge roller pair 17. The loading portion 5 that catches the medium M discharged is disposed downstream of the discharge section 19.

The medium M having been printed is conveyed from the discharge section 19 toward the loading portion 5 by the discharge roller pair 17. A regulatory roller 18 is disposed upstream of the discharge driven roller 17b. The regulatory roller 18 prevents the medium M from lifting at the upstream of the discharge driven roller 17b. The discharge driven roller 17b and the regulatory roller 18 are serrated rollers having protrusions on outer peripheries.

The printing apparatus 1 includes a inverting mechanism 20 that inverts the medium M, and can perform printing on both surfaces of the medium M.

The inverting mechanism 20 is disposed at the backward direction Bd side of the conveyance roller pair 12. The inverting mechanism 20 includes a inverting roller 22 that inverts the medium M, and a plurality of driven rollers that are biased against the inverting roller 22 and are driven to rotate. The plurality of driven rollers includes a first driven roller 23, a second driven roller 24, and a third driven roller 25. The inverting mechanism 20 inverts the medium M by conveying the medium M along a inverting path R surrounding the inverting roller 22.

In the printing apparatus 1, when printing is performed on both surfaces of the medium M, first, printing is performed on a first surface of the medium M by the printhead 31. Subsequently, the medium M is returned to the upstream of the discharge roller pair 17 by reverse feeding operations of the conveyance roller pair 12 and the discharge roller pair 17.

The medium M is fed from a portion indicated by an arrow A to the inverting path R by the reverse feeding operation of the discharge roller pair 17. Further, the medium M passes through the inverting path R and is returned to the conveyance path S from a portion indicated by an arrow B. The portion indicated by the arrow A represents a position where the inverting path R branches from the conveyance path S, and the portion indicated by the arrow B represents a position where the inverting path R merges with the conveyance path S.

The medium M that has been inverted and returned to the conveyance path S is fed to below the printhead 31 again by the conveyance roller pair 12, and printing is performed on a second surface that is a surface opposite to the first surface. The medium M having the second surface on which printing has been performed by the printhead 31 is discharged from the discharge section 19 to the loading portion 5 by the discharge roller pair 17.

As illustrated in FIG. 4, the platen 14 includes a plurality of ribs 142 on an opposed surface 141 facing the positive side in the Z-axis direction of a base portion 14a. A part of the opposed surface 141 faces the printhead 31. Each of the plurality of ribs 142 is formed integrally with the base portion 14a and comes into contact with the medium M. Each of the plurality of ribs 142 is formed so as to protrude from the opposed surface 141 toward the positive side in the Z-axis direction. The plurality of ribs 142 is arranged at intervals in the X-axis direction. Further, the plurality of ribs 142 is arranged at intervals in the Y-axis direction. That is, the plurality of ribs 142 is continuously disposed along each of the width direction and the conveyance direction of the medium M. The plurality of ribs 142 are arranged so as to correspond to a plurality of standard sizes of the medium M, such as a postcard size and an A4 size.

A medium support surface 143 which includes upper surfaces of the plurality of ribs 142 is a surface along the X-Y plane. The medium support surface 143 is a surface that supports the medium M conveyed onto the platen 14. The widths, that is, the lengths in the X-axis direction of the ribs 142 are substantially the same as each other. In the plurality of ribs 142, the length in the Y-axis direction of the rib 142 which is formed at an end portion at the positive side in the Y-axis direction of the base portion 14a, that is, an upstream end portion is longer than the length in the Y-axis direction of the rib 142 formed at other positions.

### 2. Cleaning of Platen in Conveyance Path

The printing apparatus 1 of the inkjet type prints an image on the medium M by causing the printhead 31 to eject the ink in accordance with the image data. On this occasion, minute droplets are also generated along with the ejection operation of the printhead 31, and the droplets are suspended as mist and adhere to the conveyance path S of the printing apparatus 1 in some cases. In the conveyance path S, when the mist adheres to the surface of the platen 14, in particular, to the medium support surface 143, there occurs a concern that the medium M on which printing is subsequently performed may be contaminated.

The printing apparatus 1 according to the present embodiment is configured to clean the dirt on the medium support surface 143 of the platen 14 using the medium M in the conveyance path S. The printing apparatus 1 conveys the medium M to cause the medium M to scrape against the medium support surface 143 of the platen 14 thereby wiping away the dirt on the medium support surface 143 with the medium M.

The printing apparatus 1 according to the present embodiment does not impair usability unlike the apparatus described in JP-A-2021-130537. In addition, the size of the printing apparatus 1 is not increased unlike the apparatus described in JP-A-2009-234785. The printing apparatus 1 realizes cleaning of the medium support surface 143 of the platen 14 by conveying the medium M without impairing usability and without increasing the size of the apparatus. To this end, the printing apparatus 1 according to the present embodiment devises a method of conveying the medium M.

Hereinafter, a method of conveying the medium M devised for cleaning the platen 14 in the conveyance path S and a configuration provided to the printing apparatus 1 for realizing that conveyance method will be described.

### 2.1. Configuration for Cleaning Platen in Conveyance Path

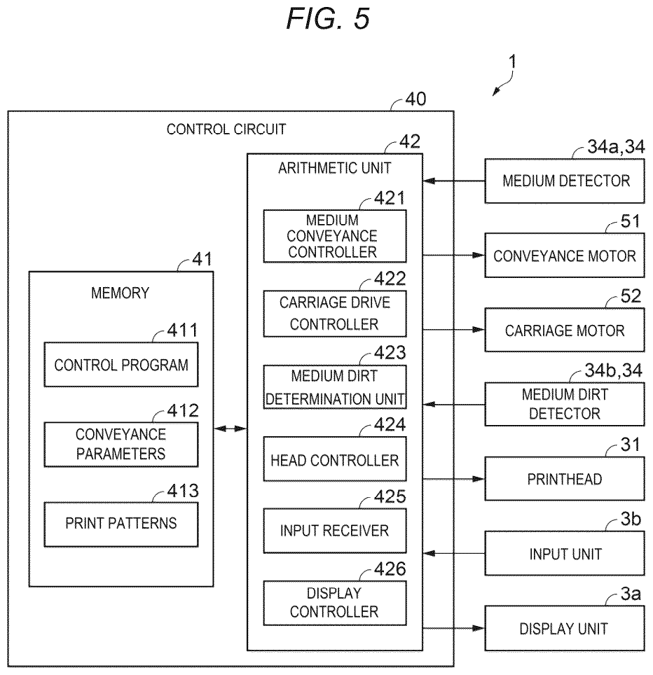

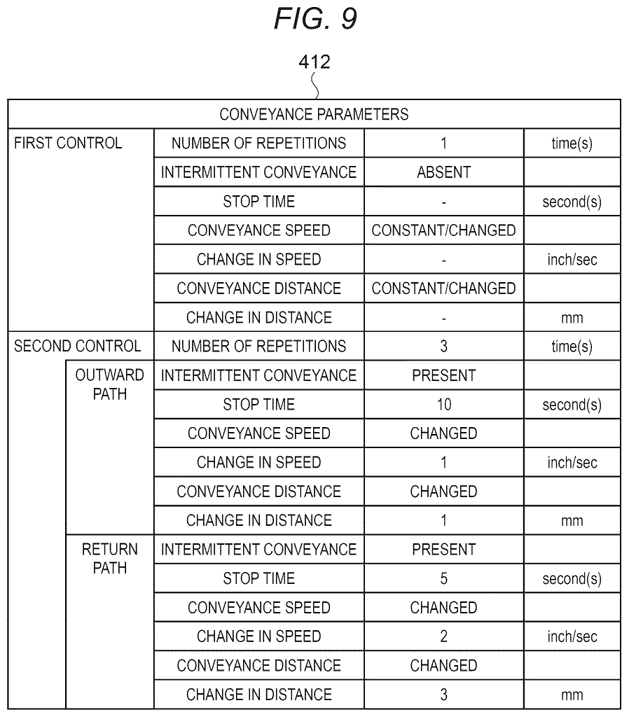

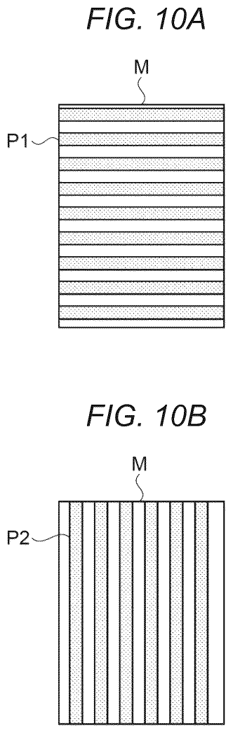

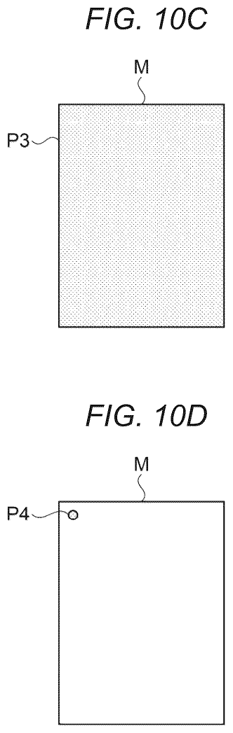

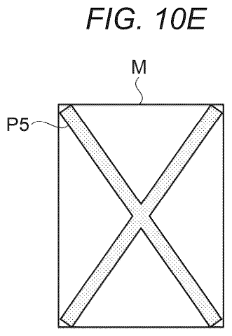

FIG. 5 is a block diagram showing an electrical configuration of the printing apparatus 1. FIG. 9 is a diagram showing an example of conveyance parameters. FIGS. 10A to 10E are diagrams each illustrating an example of printing, and illustrate print patterns P1, P2, P3, P4, and P5 printed on the medium M during the cleaning of the platen 14.

As illustrated in FIG. 5, the printing apparatus 1 includes a control circuit 40. The control circuit 40 is a processor such as a central processing unit (CPU). The control circuit 40 includes a memory 41 and an arithmetic unit 42, and controls each unit of the printing apparatus 1 with the arithmetic unit 42 in accordance with a control program stored in the memory 41. In the present embodiment, the control circuit 40 is an example of a controller.

The memory 41 includes a read only memory (ROM), a random access memory (RAM), and so on. The memory 41 may be mounted on the same chip as the control circuit 40 or may be mounted on another chip.

The memory 41 includes a control program storage area 411, a conveyance parameter storage area 412, and a print pattern storage area 413. The control program storage area 411 stores the control program. The conveyance parameter storage area 412 stores the conveyance parameters. The print pattern storage area 413 stores the print patterns P1, P2, P3, P4, and P5.

The control program stored in the control program storage area 411 includes a control program for cleaning the platen 14.

As illustrated in FIG. 9, the conveyance parameter storage area 412 stores setting values of the conveyance parameters related to the conveyance of the medium M when a cleaning mode of the platen 14 is executed. The conveyance parameters include the number of repetitions, presence or absence of intermittent conveyance, the stop time in the intermittent conveyance, a conveyance speed, a conveyance distance, and so on. The conveyance parameters are set for each of first control and second control. Further, in the second control, the conveyance parameters are set for each of an outward path and a return path. Note that the conveyance parameters may be set for each of the outward path and the return path also in the first control. Each of the setting values of the conveyance parameters is set to a predetermined value in advance at the time of factory shipment, but may be configured to be able to be changed by a user to a desired value.

The first control is control of executing a first step during the cleaning of the platen 14. The first step is a step of wiping away the dirt on the platen 14 by causing a first surface of the medium M to scrape against the medium support surface 143 of the platen 14 while conveying the medium M in the forward direction Fd.

The second control is control of executing a second step and a third step that is performed continuously from the second step. A step to be executed by the second control includes the second step and the third step. The second step is a step of wiping away the dirt on the platen 14 by conveying the medium M in the backward direction Bd while causing the first surface of the medium M to scrape against the medium support surface 143 of the platen 14. The third step is a step of wiping away the dirt on the platen 14 by causing a second surface of the medium M to scrape against the medium support surface 143 of the platen 14 while conveying the medium M in the forward direction Fd after inverting the medium M after the second step. In the second control, the outward path is a step of conveying the medium M in the backward direction Bd, and the return path is a step of conveying the medium M in the forward direction Fd.

The number of repetitions sets the number of repetitions of the first control or the number of repetitions of the second control. A default number is one.

When the number of repetitions of the first control is set to two, a first outward step of conveying the medium M in the forward direction Fd, a first return step of conveying the medium M in the backward direction Bd, and a second outward step of conveying the medium M in the forward direction Fd are executed. The first outward step is a step of wiping away dirt on the platen 14 by conveying the medium M in the forward direction Fd while causing the first surface of the medium M to scrape against the medium support surface 143 of the platen 14. The first return step is a step of wiping away dirt on the platen 14 by conveying the medium M in the backward direction Bd while causing the first surface of the medium M to scrape against the medium support surface 143 of the platen 14. The second outward step is a step of wiping away dirt on the platen 14 by conveying the medium M in the forward direction Fd while causing the first surface of the medium M to scrape against the medium support surface 143 of the platen 14. That is, when the number of repetitions of the first control is set to two, reciprocal conveyance of the medium M is performed 1.5 times. In the first outward step of the first control, the reciprocal conveyance of the medium M may be performed so that the medium M is alternately conveyed little by little in the forward direction Fd and the backward direction Bd. For example, in the first outward step of the first control, the medium M may be conveyed by a distance of 1 inch in the forward direction Fd, and then conveyed by a distance of 1 inch in the backward direction Bd. In the first return step of the first control, the reciprocal conveyance of the medium M may be performed so that the medium M is alternately conveyed little by little in the backward direction Bd and the forward direction Fd. For example, in the first return step of the first control, the medium M may be conveyed by a distance of 1 inch in the backward direction Bd, and then conveyed by a distance of 1 inch in the forward direction Fd. The conveyance distance of such reciprocal conveyance is not limited to 1 inch, and any conveyance distance can be adopted. The conveyance distance of the reciprocal conveyance may be changed for each conveyance, and the conveyance speed may be changed for each conveyance of the reciprocal conveyance.

When the number of repetitions of the second control is set to two, the first outward step, the first return step, the second outward step, and the second return step are executed in this order. The first outward step is a step of wiping away dirt on the platen 14 by conveying the medium M in the backward direction Bd while causing the first surface of the medium M to scrape against the medium support surface 143 of the platen 14. The first return step is a step of wiping away dirt on the platen 14 by conveying the medium M in the forward direction Fd while causing the second surface of the medium M to scrape against the medium support surface 143 of the platen 14 after inverting the medium M. The second outward step is a step of wiping away dirt on the platen 14 by conveying the medium M in the backward direction Bd while causing the second surface of the medium M to scrape against the medium support surface 143 of the platen 14. The second return step is a step of wiping away dirt on the platen 14 by conveying the medium M in the forward direction Fd while causing the first surface of the medium M to scrape against the medium support surface 143 of the platen 14 after inverting the medium M. That is, when the number of repetitions of the second control is set to two, the reciprocal conveyance of the medium M is performed 2 times. In the first outward step of the second control, the reciprocal conveyance of the medium M may be performed so that the medium M is alternately conveyed little by little in the backward direction Bd and the forward direction Fd. For example, in the first outward step of the second control, the medium M may be conveyed by a distance of 1 inch in the backward direction Bd, and then conveyed by a distance of 1 inch in the forward direction Fd. In the first return step of the second control, the reciprocal conveyance of the medium M may be performed so that the medium M is alternately conveyed little by little in the forward direction Fd and the backward direction Bd. For example, in the first return step of the second control, the medium M may be conveyed by a distance of 1 inch in the forward direction Fd, and then conveyed by a distance of 1 inch in the backward direction Bd. The conveyance distance of such reciprocal conveyance is not limited to 1 inch, and any conveyance distance can be adopted. The conveyance distance of the reciprocal conveyance may be changed for each conveyance, and the conveyance speed may be changed for each conveyance of the reciprocal conveyance.

In the intermittent conveyance, whether to perform the intermittent conveyance is set. The intermittent conveyance is a conveyance method in which conveyance and stop of the medium M are alternately repeated in the outward path or the return path, and is also referred to as a step feed.

As the stop time, the stop time in the intermittent conveyance is set. When the stop time is set to 10 seconds, the next conveyance is started 10 seconds after the medium M is stopped in the intermittent conveyance.

The conveyance speed sets whether to change the conveyance speed in each conveyance period in the intermittent conveyance.

The change in speed is set when the conveyance speed is changed. In the present embodiment, control is performed so that the value set as the change in speed is sequentially added. For example, when the change in speed is set to 1 inch/sec, the conveyance speed in each conveyance period increases by 1 inch/sec each time the medium M stops. Note that the conveyance speed in each conveyance period may be controlled to be decreased every time the medium M stops.

The conveyance distance sets whether to change the conveyance distance in each conveyance period in the intermittent conveyance.

The change in distance is set when changing the conveyance distance. In the present embodiment, control is performed so that the value set as the change in distance is sequentially added. For example, when the change in distance is set to 1 mm, the conveyance distance in each conveyance period increases by 1 mm each time the medium M stops. Note that the conveyance distance in each conveyance period may be controlled to be decreased every time the medium M stops.

The print pattern storage area 413 stores print pattern data for printing the print patterns P1, P2, P3, P4, and P5 shown in the print examples in FIGS. 10A to 10E.

The arithmetic unit 42 is electrically coupled to the medium detector 34a, the conveyance motor 51, the carriage motor 52, the medium dirt detector 34b, the printhead 31, the input unit 3b, and the display unit 3a. The arithmetic unit 42 transmits and receives signals such as various control signals and various notifications to and from the elements electrically coupled.

The arithmetic unit 42 includes a medium conveyance controller 421, a carriage drive controller 422, a medium dirt determination unit 423, a head controller 424, an input receiver 425, and a display controller 426.

The medium conveyance controller 421 controls the conveyance of the medium M by the conveyance roller pair 12 by controlling the conveyance motor 51 based on the control program and the conveyance parameters. Note that the control program is stored in the control program storage area 411. Further, the conveyance parameters are stored in the conveyance parameter storage area 412.

The carriage drive controller 422 controls the carriage motor 52 based on the control program to control the movement of the carriage 32.

When receiving a detection signal representing the presence or absence of dirt or the degree of dirt on the medium M from the medium dirt detector 34b, the medium dirt determination unit 423 determines the presence or absence of dirt on the medium M based on the detection signal. The arithmetic unit 42 repeatedly performs the second control as described later based on the determination by the medium dirt determination unit 423.

The head controller 424 controls the printhead 31 based on the control program to print, on the medium M, images such as the print patterns P1, P2, P3, P4, and P5 stored in the print pattern storage area 413.

The input receiver 425 receives an operation of the user input from the input unit 3b.

The display controller 426 displays necessary information on the display unit 3a based on the control program.

### 2.2. Method of Cleaning Platen in Conveyance Path

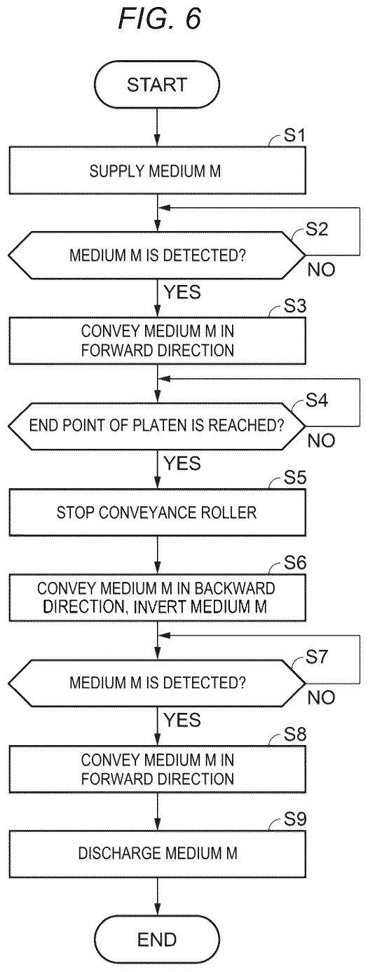

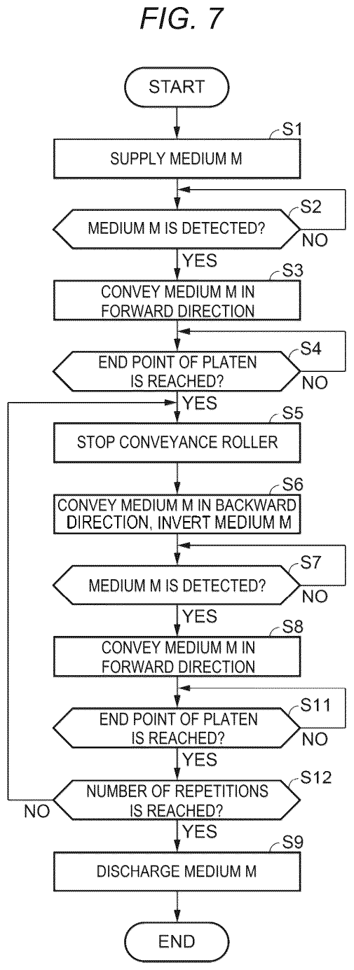

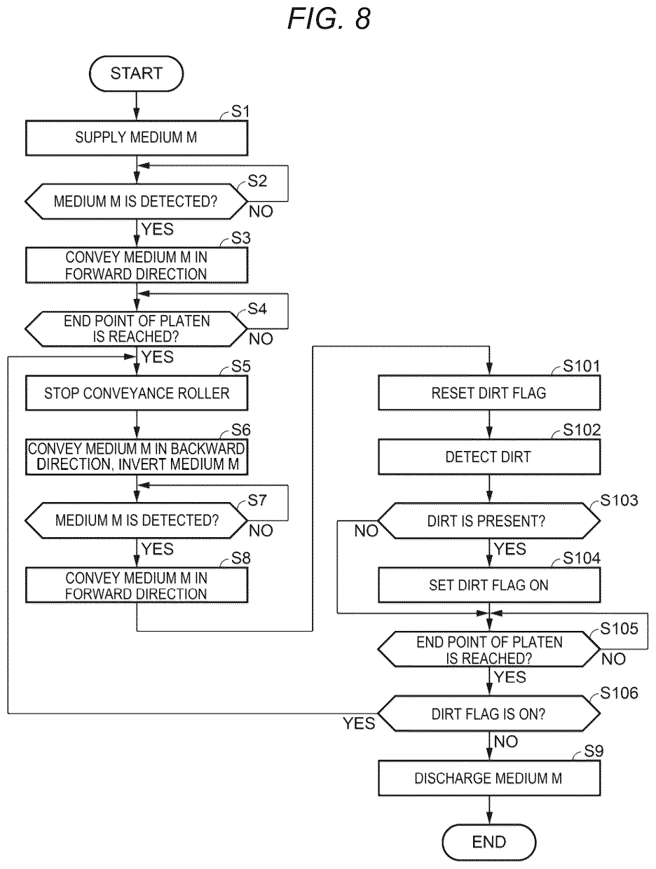

FIG. 6 is a flowchart illustrating a method of cleaning the platen 14 of the printing apparatus 1. FIG. 7 is a flowchart according to Modified Example 1 of the cleaning method in FIG. 6. FIG. 8 is a flowchart according to Modified Example 2 of the cleaning method in FIG. 6.

First, a cleaning method for the printing apparatus 1 will be described with reference to FIG. 6.

When the user operates the input unit 3b to select execution of cleaning of the platen 14 from a maintenance menu displayed on the display unit 3a, the execution of cleaning is instructed. Based on the execution instruction of the cleaning, the input receiver 425 receives execution of a cleaning mode for cleaning the platen 14. Based on the input receiver 425 receiving the execution of the cleaning mode, the control circuit 40 executes the control program for cleaning the platen 14 stored in the control program storage area 411.

Note that the execution of the cleaning mode may be led by the printing apparatus 1. For example, it may be programmed to execute the cleaning mode every 10 days or at a fixed date and time using a timer or a counter, or it may be programmed to accumulate use time and execute the cleaning mode when a predetermined accumulated use time is reached. Further, it may be programmed to count the number of printed sheets and execute the cleaning mode when a printed amount reaches a predetermined amount. The execution of the cleaning mode led by the printing apparatus 1 may be only displaying a screen which prompts the user to execute the cleaning mode on the display unit 3a. In the present embodiment, the cleaning mode in which the platen 14 is cleaned is an example of a cleaning mode in which the conveyance path S is cleaned.

In step S1, the medium M is supplied to the conveyance path S. The arithmetic unit 42 drives a motor (not illustrated) to rotate the feed roller 11 to supply the medium M to the conveyance path S.

In step S2, detection of the medium M is performed, and when the medium M is detected, the process proceeds to step S3. The detection of the medium M is performed by a medium detector (not illustrated) as a medium detector that detects the presence or absence of the medium M. The medium detector is disposed near an upstream entrance of the conveyance roller pair 12.

In step S3, the medium M is conveyed in the forward direction Fd. Due to step S3, the conveyance of the medium M in the forward direction Fd by the conveyance roller pair 12 is started. The medium conveyance controller 421 controls the drive of the conveyance motor 51 based on the setting values of the conveyance parameters in the first control to thereby rotate the conveyance driving roller 12a forward. Accordingly, the medium M is conveyed in the forward direction Fd. Note that the setting values of the conveyance parameters in the first control are stored in the conveyance parameter storage area 412. By the medium M being conveyed in the forward direction Fd, the first surface of the medium M at the negative side in the Z-axis direction moves while scraping against the medium support surface 143 of the platen 14 to wipe away the dirt on the medium support surface 143. Note that in the present embodiment, step S3 and step S4 in FIG. 6 are an example of the first control.

As shown in FIG. 9, in the present embodiment, the number of repetitions (once) and the intermittent conveyance (ABSENT) are set in the conveyance parameter storage area 412 as the conveyance parameters in the first control. Therefore, in step S3, the medium conveyance controller 421 rotates the conveyance driving roller 12a forward without intermittently driving the conveyance driving roller 12a to convey the medium M once in the forward direction Fd.

In step S4, it is detected whether the medium M has reached an end point 14e (see FIG. 3) of the platen 14. The end point 14e of the platen 14 is a downstream end of the platen 14. The detection in step S4 can be performed by, for example, a code wheel and an encoder (not illustrated).

When the medium M reaches the end point 14e of the platen 14, the conveyance of the medium M is stopped in step S5. The medium conveyance controller 421 stops driving the conveyance motor 51 to stop the conveyance roller pair 12.

In step S6, the medium M is conveyed in the backward direction Bd. Due to step S6, the conveyance of the medium M in the backward direction Bd by the conveyance roller pair 12 is started. The medium conveyance controller 421 controls the drive of the conveyance motor 51 based on the setting values of the conveyance parameters of the outward path in the second control to thereby rotate the conveyance driving roller 12a backward. Accordingly, the medium M is conveyed in the backward direction Bd. Note that the setting values of the conveyance parameters of the outward path in the second control are stored in the conveyance parameter storage area 412. By the medium M being conveyed in the backward direction Bd, the first surface of the medium M at the negative side in the Z-axis direction moves once again while scraping against the medium support surface 143 of the platen 14 to wipe away the dirt on the medium support surface 143. Note that in the present embodiment, step S6 to step S8 in FIG. 6 are an example of the second control.

As shown in FIG. 9, the number of repetitions (three times) is set as a parameter of the second control. In addition, as the parameters of the outward path in the second control, the intermittent conveyance (PRESENT), the stop time (10 seconds), the conveyance speed (CHANGED), the change in speed (1 inch/sec), the conveyance distance (CHANGED), and the change in distance (1 mm) are set. Note that the parameters in the second control and the parameters of the outward path in the second control are stored in the conveyance parameter storage area 412. In step S6, the medium conveyance controller 421 rotates the conveyance driving roller 12a backward while intermittently driving the conveyance driving roller 12a to intermittently convey the medium M in the backward direction Bd. In the conveyance period of the medium M in the backward direction Bd, the conveyance driving roller 12a repeats driving for a predetermined time and stopping for 10 seconds. Further, the conveyance speed of the medium M increases by 1 inch/sec every time the medium M stops. Further, the conveyance distance of the medium M increases by 1 mm every time the medium M stops.

By being conveyed in the backward direction Bd, the medium M is fed from a portion indicated by the arrow A to the inverting path R. After the medium M passes through the inverting path R, the first surface and the second surface of the medium M are reversed, and the medium M is returned to the conveyance path S from a portion indicated by the arrow B.

Subsequently, when the medium M is detected by the medium detector in step S7, the process proceeds to step S8. In step S8, the medium conveyance controller 421 controls drive of the conveyance motor 51 to thereby rotate the conveyance driving roller 12a forward to convey the medium M in the forward direction Fd. On this occasion, the drive of the conveyance motor 51 is controlled based on the setting values of the parameters of the return path in the second control stored in the conveyance parameter storage area 412. By the medium M being conveyed in the forward direction Fd, the second surface of the medium M moves while scraping against the medium support surface 143 of the platen 14 to wipe away the dirt on the medium support surface 143.

As shown in FIG. 9, as the conveyance parameters of the return path in the second control, the intermittent conveyance (PRESENT), the stop time (5 seconds), the conveyance speed (CHANGED), the change in speed (2 inches/sec), the conveyance distance (CHANGED), and the change in distance (3 mm) are set. Note that the conveyance parameters of the return path in the second control are stored in the conveyance parameter storage area 412. In step S8, the medium conveyance controller 421 rotates the conveyance driving roller 12a forward while intermittently driving the conveyance driving roller 12a to intermittently convey the medium M in the forward direction Fd. In the conveyance period of the medium M in the forward direction Fd, the conveyance driving roller 12a repeats driving for a predetermined time and stopping for 5 seconds. Further, the conveyance speed of the medium M increases by 2 inches/sec every time the medium M stops. Further, the conveyance distance of the medium M increases by 3 mm every time the medium M stops.

Subsequently, in step S9, the medium M is conveyed in the forward direction Fd by the discharge roller pair 17 and is then discharged from the discharge section 19.

In the present embodiment, by conveying the medium M in the forward direction Fd due to the first control from step S3 to step S4, the platen 14 is wiped once with the first surface of the medium M. By conveying the medium M in the backward direction Bd by the second control from step S6 to step S8, the platen 14 is wiped once with the first surface of the medium M, and then, by inverting the medium M and then conveying the medium M in the forward direction Fd, the platen 14 is wiped once with the second surface of the medium M. That is, in the method of cleaning the platen 14 illustrated in FIG. 6, the platen 14 is wiped with the medium M three times in total. Therefore, in the method of cleaning the platen 14 in the conveyance path S shown in FIG. 6, it is possible to clean the platen 14 without reducing usability or increasing the size of the printer.

In the present embodiment, in the first control and the second control, the conveyance of the medium M is performed based on the conveyance parameters. Therefore, it is possible to further improve the cleaning effect of the platen 14 depending on the setting of the conveyance parameters. For example, by setting the number of repetitions to a plural number in at least one of the first control and the second control, the cleaning effect of the platen 14 can be enhanced compared to when the number of repetitions is one. In addition, by setting the intermittent conveyance to be PRESENT in at least one of the first control and the second control, it is possible to enhance the cleaning effect of the platen 14 compared to when setting of the intermittent conveyance is ABSENT. Further, the cleaning effect of the platen 14 can be enhanced by setting the conveyance speed of the intermittent conveyance to be CHANGED or setting the conveyance distance to be CHANGED. Obviously, the cleaning effect can be obtained by repeating none of the first control and the second control. To repeat none of the first control and the second control corresponds to setting the number of repetitions to one in the present embodiment. In addition, the cleaning effect can be obtained by performing the intermittent conveyance in none of the first control and the second control.

In the present embodiment, there is adopted the configuration in which the cleaning of the platen 14 is performed by the first control and the second control, but a configuration in which only the first control is performed may be adopted. In this case, it is preferable to enhance the cleaning effect of the platen 14 by setting the intermittent conveyance to PRESENT. Additionally or alternatively, it is preferable to enhance the cleaning effect of the platen 14 by setting the number of repetitions to a plural number. In particular, when the printing apparatus 1 does not include the inverting mechanism 20, the printing apparatus 1 has the configuration in which the platen 14 is cleaned only by the first control. Therefore, in order to enhance the cleaning effect, the intermittent conveyance is set to PRESENT, and additionally or alternatively the number of repetitions is set to a plural number.

In the present embodiment, any one of the print patterns P1, P2, P3, P4, and P5 illustrated in FIGS. 10A to 10E may be printed on the medium M in any one of step S3, step S6, and step S8. By printing any one of the print patterns P1, P2, P3, P4, and P5 illustrated in FIGS. 10A to 10E on the medium M, it is possible to generate cockling in the medium M. It is possible to make it easy for the medium M to be brought into contact with the medium support surface 143 of the platen 14 by the cockling. Therefore, the cleaning effect of the platen 14 with the medium M can be enhanced. The ink can be used to print the print patterns P1, P2, P3, P4, and P5. The color of the ink does not matter. Alternatively, printing may be performed using a cleaning-dedicated liquid instead of the ink. In the present embodiment, the print patterns P1, P2, P3, P4, and P5 printed with the ink are examples of patterns with the droplets.

Each of the print patterns P1, P2, P3, P4, and P5 illustrated in FIGS. 10A to 10E is an example of a preferable print pattern, but is not a limitation. Other patterns may be used as long as cockling can be caused in the medium M.

### 2.2.1. Method of Cleaning Platen in Conveyance Path According to Modified Example 1

FIG. 7 shows a flowchart according to Modified Example 1 of the cleaning method shown in FIG. 6. In the flowchart in FIG. 7, step S11 and step S12 are added between step S8 and step S9 of the flowchart in FIG. 6. In Modified Example 1, the control is performed so that the second control is repeatedly performed the number of times set in the conveyance parameters due to step S11 and step S12 thus added.

In step S11, it is detected whether the medium M conveyed in the forward direction Fd in step S8 has reached the end point 14e of the platen 14.

When the medium M reaches the end point 14e of the platen 14, it is determined in step S12 whether the number of executions of the second control has reached the number of repetitions set in the conveyance parameter storage area 412. When the number of executions of the second control does not reach the number of repetitions set therein, the process returns to step S5 to repeat step S5 to step S11. When the number of executions of the second control reaches the number of repetitions set therein, the process proceeds to step S9 to discharge the medium M from the discharge section 19.

When the cleaning method according to Modified Example 1 is applied to the printing apparatus 1 that does not include the inverting mechanism 20, the configuration in which the platen 14 is cleaned only by the first control is adopted. Therefore, in order to enhance the cleaning effect, it is preferable to set the intermittent conveyance to be PRESENT and additionally or alternatively set the number of repetitions to a plural number. In this case, in step S6 in FIG. 7, the medium M is conveyed in the backward direction Bd, and in step S7, it is detected whether the medium M has reached a start point of the platen 14, and when the medium M reaches the start point of the platen 14, the conveyance of the medium M is stopped. The start point of the platen 14 is an upstream end of the platen 14. Whether the medium M has reached the start point of the platen 14 can be detected by, for example, a code wheel and an encoder (not illustrated).

### 2.2.2. Method of Cleaning Platen in Conveyance Path According to Modified Example 2

FIG. 8 shows a flowchart according to Modified Example 2 of the cleaning method shown in FIG. 6. In the flowchart in FIG. 8, step S101 to step S106 are added between step S8 and step S9 of the flowchart in FIG. 6. In Modified Example 2, dirt on the medium M is detected by step S101 to step S106 thus added, and when the medium M is dirty, the control is performed so that the second control is repeatedly performed.

In step S101, the arithmetic unit 42 resets a dirt flag.

In step S102, the medium dirt detector 34b detects dirt on the medium M conveyed in the forward direction Fd and then transmits a detection signal to the arithmetic unit 42.

In step S103, the medium dirt determination unit 423 determines the presence or absence of dirt on the medium M based on the detection signal transmitted from the medium dirt detector 34b. When it is determined that there is no dirt on the medium M, the process proceeds to step S105, and when it is detected that there is dirt on the medium M, the process proceeds to step S104.

In step S104, the arithmetic unit 42 turns on the dirt flag.

In step S105, the arithmetic unit 42 detects whether the medium M conveyed in the forward direction Fd in step S8 has reached the end point 14e of the platen 14. When the medium M reaches the end point 14e of the platen 14, the process proceeds to step S106, and the arithmetic unit 42 checks the dirt flag.

In step S106, when the dirt flag is on, the process proceeds to step S5. Accordingly, step S5 to step S105 are repeated. On the other hand, when the dirt flag is not on, the process proceeds to step S9 and the medium M is discharged from the discharge section 19.

In the cleaning method according to Modified Example 2, when dirt on the medium M is detected, the setting of the conveyance parameters may be changed such that the cleaning effect is enhanced. For example, when the setting of the intermittent conveyance is ABSENT, the setting of the intermittent conveyance is changed to PRESENT. Further, in the setting of the intermittent conveyance, the setting of the stop time may be lengthened, the conveyance speed may be changed, the conveyance distance may be changed, or the setting of the conveyance parameters may be changed between the forward path and the return path. Further, the number of repetitions may be increased. The change in setting of the conveyance parameters when dirt on the medium M is detected is performed by the arithmetic unit 42 based on the control program. On this occasion, it is possible to adopt a configuration in which the recommended setting is displayed on the display unit 3a to allow the user to change the setting of the conveyance parameters. Modified Example 2 is not limited to a configuration in which the second control is repeated when dirt on the medium M is detected. In Modified Example 2, it is possible to adopt a configuration in which the setting of the conveyance parameters in the second control is changed when dirt on the medium M is detected instead of the configuration in which the second control is repeated.

In the cleaning method according to Modified Example 2, the printing apparatus 1 may alert the user when dirt on the medium M is detected. The alert is performed by, for example, displaying a warning message such as “Please wipe the platen 14 with a cotton swab.”on the display unit 3a.

In the cleaning method according to Modified Example 2, when dirt on the medium M is detected, the printing apparatus 1 may print any of the print patterns P1, P2, P3, P4, and P5 illustrated in FIGS. 10A to 10E on the medium M.

As described above with reference to the drawings, according to the present embodiment, the following advantages can be obtained.

The printing apparatus 1 according to the present embodiment includes the conveyance path S through which the medium M is conveyed, the conveyance roller pair 12 as a conveyance roller that conveys the medium M along the conveyance path S, the platen 14 as a support portion that supports the medium M conveyed through the conveyance path S, the printhead 31 that performs printing on the medium M by ejecting droplets onto the medium M supported by the platen 14, the inverting path R that branches from the conveyance path S at a position at the backward direction Bd side of the conveyance roller pair 12, inverts the medium M conveyed in the backward direction Bd, and then merges the medium M with the conveyance path S, defining the direction from the conveyance roller pair 12 toward the printhead 31 on the conveyance path S as the forward direction Fd, and the direction opposite to the forward direction Fd as the backward direction Bd, and the control circuit 40 as the controller that controls drive of the conveyance roller pair 12, wherein the control circuit 40 executes, based on the reception of the execution of the cleaning mode of cleaning the conveyance path S, the first control of causing the medium M to reach at least the platen 14 by causing the conveyance roller pair 12 to convey the medium M in the forward direction Fd and then executes the second control of merging the medium M with the conveyance path S via the inverting path R by causing the conveyance roller pair 12 to convey the medium M in the backward direction Bd, and causing the conveyance roller pair 12 to convey the medium M in the forward direction Fd.

As described above, the printing apparatus 1 can wipe away the dirt on the platen 14 using both surfaces of the medium M by executing the first control and the second control. Therefore, according to the printing apparatus 1 of the present embodiment, it is possible to clean the platen 14 in the conveyance path S without degrading the usability of the printing apparatus 1 or increasing the size of the printing apparatus 1.

In the printing apparatus 1 of the present embodiment, the control circuit 40 repeatedly executes the second control.

Therefore, according to the printing apparatus 1 of the present embodiment, it is possible to enhance the effect of cleaning the platen 14 with the medium M.

The printing apparatus 1 of the present embodiment further includes the medium dirt detector 34b as a sensor that detects dirt on the medium M, wherein when executing the second control, the control circuit 40 repeatedly executes the second control based on a result of detection of the dirt on a surface at an opposite side to the platen 14 of the medium M which is performed by the medium dirt detector 34b.

Therefore, according to the printing apparatus 1 of the present embodiment, it is possible to enhance the effect of cleaning the platen 14 with the medium M.

In the printing apparatus 1 according to the present embodiment, the control circuit 40 causes the conveyance roller pair 12 to intermittently convey the medium M in at least one of the first control and the second control.

Therefore, according to the printing apparatus 1 of the present embodiment, it is possible to enhance the effect of cleaning the platen 14 with the medium M.

In the printing apparatus 1 according to the present embodiment, the control circuit 40 causes the conveyance roller pair 12 to change the conveyance speed of the medium M every intermittence of the intermittent conveyance.

Therefore, according to the printing apparatus 1 of the present embodiment, it is possible to enhance the effect of cleaning the platen 14 with the medium M.

In the printing apparatus 1 according to the present embodiment, the control circuit 40 causes the conveyance roller pair 12 to change the conveyance distance of the medium M every intermittence of the intermittent conveyance.

Therefore, according to the printing apparatus 1 of the present embodiment, it is possible to enhance the effect of cleaning the platen 14 with the medium M.

In the printing apparatus 1 according to the present embodiment, the control circuit 40 can change the stop time of the medium M in the intermittent conveyance.

Therefore, according to the printing apparatus 1 of the present embodiment, it is possible to enhance the effect of cleaning the platen 14 with the medium M.

In the printing apparatus 1 according to the present embodiment, the control circuit 40 causes the conveyance roller pair 12 to reciprocally convey the medium M in at least one of the first control and the second control.

Therefore, according to the printing apparatus 1 of the present embodiment, it is possible to enhance the effect of cleaning the platen 14 with the medium M.

In the printing apparatus 1 according to the present embodiment, the control circuit 40 can change the conveyance distance of the medium M and the conveyance speed of the medium M in the reciprocal conveyance.

Therefore, according to the printing apparatus 1 of the present embodiment, it is possible to enhance the effect of cleaning the platen 14 with the medium M.

In the printing apparatus 1 according to the present embodiment, in at least one of the first control and the second control, the control circuit 40 causes the printhead 31 to eject droplets to thereby print any one of the print patterns P1, P2, P3, P4, and P5 as a pattern with the droplets on the medium M.

Therefore, according to the printing apparatus 1 of the present embodiment, it is possible to enhance the effect of cleaning the platen 14 with the medium M.

The printing apparatus 1 according to the present embodiment includes the conveyance path S through which the medium M is conveyed, the conveyance roller pair 12 as a conveyance roller that conveys the medium M along the conveyance path S, the platen 14 as a support portion that supports the medium M conveyed through the conveyance path S, the printhead 31 that performs printing on the medium M by ejecting droplets onto the medium M supported by the platen 14, and the control circuit 40 as a controller that controls drive of the conveyance roller pair 12, wherein the control circuit 40 causes the conveyance roller pair 12 to intermittently convey the medium M in the forward direction Fd as a direction from the conveyance roller pair 12 toward the printhead 31 on the conveyance path S based on the reception of the execution of the cleaning mode of cleaning the conveyance path S.

As described above, the printing apparatus 1 can wipe away the dirt on the platen 14 with the medium M by intermittently conveying the medium M in the forward direction Fd in the conveyance path S. Therefore, according to the printing apparatus 1 of the present embodiment, it is possible to clean the platen 14 without degrading the usability of the printing apparatus 1 or increasing the size of the printing apparatus 1.

The printing apparatus 1 according to the present embodiment includes the conveyance path S through which the medium M is conveyed, the conveyance roller pair 12 as a conveyance roller that conveys the medium M along the conveyance path S, the platen 14 as a support portion that supports the medium M conveyed through the conveyance path S, the printhead 31 that performs printing on the medium M by ejecting droplets onto the medium M supported by the platen 14, and the control circuit 40 as a controller that controls drive of the conveyance roller pair 12 and the printhead 31, wherein the control circuit 40 causes, based on the reception of the execution of the cleaning mode of cleaning the conveyance path S, the conveyance roller pair 12 to convey the medium M in the forward direction Fd as a direction from the conveyance roller pair 12 toward the printhead 31 on the conveyance path S and causes the printhead 31 to eject the droplets to thereby cause the printhead 31 to print any one of the print patterns P1, P2, P3, P4, and P5 as the patterns with the droplets on the medium M.

As described above, the printing apparatus 1 causes the conveyance roller pair 12 to convey the medium M in the forward direction Fd, and causes the printhead 31 to eject droplets to thereby print any one of the print patterns P1, P2, P3, P4, and P5 with the droplets on the medium M.

Therefore, by causing cockling in the medium M, it is possible to enhance the cleaning effect of the platen 14 with the medium M. Therefore, according to the printing apparatus 1 of the present embodiment, it is possible to clean the platen 14 without degrading the usability of the printing apparatus 1 or increasing the size of the printing apparatus 1.

The printing apparatus 1 according to the present embodiment includes the conveyance path S through which the medium M is conveyed, the conveyance roller pair 12 as a conveyance roller that conveys the medium M along the conveyance path S, the platen 14 as a support portion that supports the medium M conveyed through the conveyance path S, the printhead 31 that performs printing on the medium M by ejecting droplets onto the medium M supported by the platen 14, and the control circuit 40 as a controller that controls drive of the conveyance roller pair 12 and the printhead 31, wherein the control circuit 40 causes, based on the reception of the execution of the cleaning mode of cleaning the conveyance path S, the conveyance roller pair 12 to intermittently convey the medium M in the forward direction Fd as a direction from the conveyance roller pair 12 toward the printhead 31 on the conveyance path S and causes the printhead 31 to eject the droplets to thereby cause the printhead 31 to print any one of the print patterns P1, P2, P3, P4, and P5 as the patterns with the droplets on the medium M.

As described above, in the conveyance path S, the printing apparatus 1 intermittently conveys the medium M in the forward direction Fd and causes the printhead 31 to eject the droplets to thereby print any one of the print patterns P1, P2, P3, P4, and P5 with the droplets on the medium M.

Therefore, since it is possible to wipe away the dirt on the platen 14 with the medium M which is waved by the cockling while intermittently conveying the medium M, it is possible to enhance the cleaning effect of the platen 14 with the medium M. Therefore, according to the printing apparatus 1 of the present embodiment, it is possible to clean the platen 14 without degrading the usability of the printing apparatus 1 or increasing the size of the printing apparatus 1.

In the printing apparatus 1 according to the present embodiment, based on the reception of the execution of the cleaning mode of cleaning the conveyance path S, the control circuit 40 causes the conveyance roller pair 12 to convey the medium M in the forward direction Fd as a direction from the conveyance roller pair 12 toward the printhead 31 on the conveyance path S a plurality of times with conveyance in the backward direction Bd opposite to the forward direction Fd interposed therebetween.

As described above, the printing apparatus 1 performs the conveyance in the forward direction Fd a plurality of times with the conveyance in the backward direction Bd opposite to the forward direction Fd interposed therebetween. That is, the printing apparatus 1 reciprocally conveys the medium M. Therefore, according to the printing apparatus 1 of the present embodiment, it is possible to enhance the effect of cleaning the platen 14 with the medium M.

The cleaning method for the printing apparatus 1 according to the present embodiment is a cleaning method for the printing apparatus including the conveyance path S through which the medium M is conveyed, the conveyance roller pair 12 as a conveyance roller that conveys the medium M along the conveyance path S, the platen 14 as a support portion that supports the medium M conveyed through the conveyance path S, the printhead 31 that performs printing on the medium M by ejecting droplets onto the medium M supported by the platen 14, and the inverting path R that branches from the conveyance path S at a position at the backward direction Bd side of the conveyance roller pair 12, inverts the medium M conveyed in the backward direction Bd, and then merges the medium M with the conveyance path S, defining the direction from the conveyance roller pair 12 toward the printhead 31 on the conveyance path S as the forward direction Fd, and the direction opposite to the forward direction Fd as the backward direction Bd, the method including causing the medium M to reach at least the platen 14 by conveying the medium M in the forward direction Fd and then merging the medium M with the conveyance path S via the inverting path R by causing the conveyance roller pair 12 to convey the medium M in the backward direction Bd, and causing the conveyance roller pair 12 to convey the medium M in the forward direction Fd.

As described above, in the cleaning method for the printing apparatus 1, it is possible to wipe away the dirt on the platen 14 using both surfaces of the medium M by inverting the medium M. Therefore, according to the cleaning method for the printing apparatus 1 of the present embodiment, it is possible to clean the platen 14 without degrading the usability of the printing apparatus 1 or increasing the size of the printing apparatus 1.

Although the preferred embodiment is described hereinabove, the present disclosure is not limited to the embodiment described above. In addition, the configuration of each element in the present disclosure can be replaced with any configuration that exhibits substantially the same function as that of the embodiment described above, and can be added with any configuration.

### SUMMARY OF PRESENT DISCLOSURE

A summary of the present disclosure will be appended below.

### Appendix 1

A printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction, and a controller configured to control drive of the conveyance roller, wherein the controller executes, based on reception of an execution of a cleaning mode of cleaning the conveyance path, first control of causing the medium to reach at least the support portion by causing the conveyance roller to convey the medium in the forward direction and then executes second control of merging the medium with the conveyance path via the inverting path by causing the conveyance roller to convey the medium in the backward direction, and causing the conveyance roller to convey the medium in the forward direction.

As described above, the printing apparatus according to Appendix 1 can wipe away the dirt on the conveyance path using both surfaces of the medium by executing the first control and the second control. Therefore, according to the printing apparatus related to Appendix 1, it is possible to enhance the cleaning effect of the conveyance path without degrading the usability of the printing apparatus or increasing the size of the printing apparatus.

### Appendix 2

The printing apparatus according to Appendix 1, wherein the controller repeatedly executes the second control.

As described above, according to the printing apparatus related to Appendix 2, it is possible to enhance the effect of cleaning the conveyance path with the medium.

### Appendix 3

The printing apparatus according to Appendix 1 or 2, further including a sensor configured to detect dirt on the medium, wherein when the controller executes the second control, the controller repeatedly executes the second control based on a result of detection, by the sensor, of dirt on a surface of the medium at an opposite side to the support portion of the medium.

As described above, according to the printing apparatus related to Appendix 3, it is possible to enhance the effect of cleaning the conveyance path with the medium.

### Appendix 4

The printing apparatus according to any one of Appendices 1 to 3, wherein the controller causes the conveyance roller to perform intermittent conveyance of the medium in at least one of the first control and the second control.

As described above, according to the printing apparatus related to Appendix 4, it is possible to enhance the effect of cleaning the conveyance path with the medium.

### Appendix 5

The printing apparatus according to Appendix 4, wherein the controller causes the conveyance roller to change a conveyance speed of the medium every intermittence of the intermittent conveyance.

As described above, according to the printing apparatus related to Appendix 5, it is possible to enhance the effect of cleaning the conveyance path with the medium.

### Appendix 6

The printing apparatus according to Appendix 4 or 5, wherein the controller causes the conveyance roller to change a conveyance distance of the medium every intermittence of the intermittent conveyance.

As described above, according to the printing apparatus related to Appendix 6, it is possible to enhance the effect of cleaning the conveyance path with the medium.

### Appendix 7

The printing apparatus according to any one of Appendices 4 to 6, wherein the controller is configured to change the stop time of the medium in the intermittent conveyance.

As described above, according to the printing apparatus related to Appendix 7, it is possible to enhance the effect of cleaning the conveyance path with the medium.

### Appendix 8

The printing apparatus according to any one of Appendices 1 to 7, wherein the controller causes the conveyance roller to perform reciprocal conveyance of the medium in at least one of the first control and the second control.

As described above, according to the printing apparatus related to Appendix 8, it is possible to enhance the effect of cleaning the conveyance path with the medium.

### Appendix 9

The printing apparatus according to Appendix 8, wherein the controller is configured to change a conveyance distance of the medium and a conveyance speed of the medium in the reciprocal conveyance.

As described above, according to the printing apparatus related to Appendix 9, it is possible to enhance the effect of cleaning the conveyance path with the medium.

### Appendix 10

The printing apparatus according to any one of Appendices 1 to 9, wherein in at least one of the first control and the second control, the controller causes the printhead to eject the droplets to thereby print a pattern with the droplets on the medium.

As described above, according to the printing apparatus related to Appendix 10, it is possible to enhance the effect of cleaning the conveyance path with the medium.

### Appendix 11

A printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller, wherein the controller causes the conveyance roller to perform intermittent conveyance of the medium in a direction from the conveyance roller toward the printhead on the conveyance path based on reception of an execution of a cleaning mode of cleaning the conveyance path.

As described above, the printing apparatus according to Appendix 11 can wipe away the dirt on the conveyance path with the medium by performing the intermittent conveyance of the medium on the conveyance path. Therefore, according to the printing apparatus of Appendix 11, it is possible to clean the conveyance path without degrading the usability of the printing apparatus or increasing the size of the printing apparatus.

### Appendix 12

The printing apparatus according to Appendix 11, wherein the controller causes the conveyance roller to change a conveyance speed of the medium every intermittence of the intermittent conveyance.

As described above, according to the printing apparatus related to Appendix 12, it is possible to enhance the effect of cleaning the conveyance path with the medium.

### Appendix 13

The printing apparatus according to Appendix 11 or 12, wherein the controller causes the conveyance roller to change a conveyance distance of the medium every intermittence of the intermittent conveyance.

As described above, according to the printing apparatus related to Appendix 13, it is possible to enhance the effect of cleaning the conveyance path with the medium.

### Appendix 14

The printing apparatus according to any one of Appendices 11 to 13, wherein the controller is configured to change the stop time of the medium in the intermittent conveyance.

As described above, according to the printing apparatus related to Appendix 14, it is possible to enhance the effect of cleaning the conveyance path with the medium.

### Appendix 15

A printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller and the printhead, wherein the controller causes, based on reception of an execution of a cleaning mode of cleaning the conveyance path, the conveyance roller to convey the medium in a direction from the conveyance roller toward the printhead on the conveyance path, and causes the printhead to eject the droplets to thereby print a pattern with the droplets on the medium.

As described above, the printing apparatus according to Appendix 15 causes the conveyance roller to convey the medium and causes the printhead to eject the droplets to thereby print a pattern with the droplets on the medium. Therefore, by causing cockling in the medium, it is possible to enhance the cleaning effect of the conveyance path with the medium. Therefore, according to the printing apparatus of Appendix 15, it is possible to clean the conveyance path without degrading the usability of the printing apparatus or increasing the size of the printing apparatus.

### Appendix 16

A printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a controller configured to control drive of the conveyance roller and the printhead, wherein the controller causes, based on reception of an execution of a cleaning mode of cleaning the conveyance path, the conveyance roller to perform intermittent conveyance of the medium in a direction from the conveyance roller toward the printhead on the conveyance path, and causes the printhead to eject the droplets to thereby print a pattern with the droplets on the medium.

As described above, the printing apparatus according to Appendix 16 performs the intermittent conveyance of the medium M in the conveyance path, and causes the printhead to eject the droplets to thereby print a pattern with the droplets on the medium. Therefore, since it is possible to wipe away the dirt of the conveyance path with the medium which is waved by the cockling while intermittently conveying the medium, it is possible to improve the cleaning effect of the conveyance path with the medium. Therefore, according to the printing apparatus related to Appendix 16, it is possible to clean the conveyance path without degrading the usability of the printing apparatus or increasing the size of the printing apparatus.

### Appendix 17

The printing apparatus according to any one of Appendices 11 to 16, wherein the controller causes, based on reception of an execution of a cleaning mode of cleaning the conveyance path, the conveyance roller to convey the medium in a forward direction from the conveyance roller toward the printhead in the conveyance path a plurality of times with conveyance in a backward direction opposite to the forward direction interposed therebetween.

As described above, the printing apparatus according to Appendix 17 executes the conveyance in the forward direction a plurality of times with the conveyance in the backward direction opposite to the forward direction interposed therebetween. That is, the printing apparatus performs the reciprocal conveyance of the medium. Therefore, according to the printing apparatus related to Appendix 17, it is possible to enhance the effect of cleaning the conveyance path with the medium.

### Appendix 18

The printing apparatus according to Appendix 17, wherein the controller is configured to change a conveyance distance of the medium and a conveyance speed of the medium in the reciprocal conveyance.

As described above, according to the printing apparatus related to Appendix 18, it is possible to enhance the effect of cleaning the conveyance path with the medium.

### Appendix 19

A cleaning method for a printing apparatus including a conveyance path through which a medium is conveyed, a conveyance roller configured to convey the medium along the conveyance path, a support portion configured to support the medium conveyed through the conveyance path, a printhead configured to perform printing on the medium by ejecting droplets onto the medium supported by the support portion, and a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction, the method including causing the medium to reach at least the support portion by conveying the medium in the forward direction and then merging the medium with the conveyance path via the inverting path by causing the conveyance roller to convey the medium in the backward direction, and causing the conveyance roller to convey the medium in the forward direction.

As described above, in the cleaning method for the printing apparatus according to Appendix 19, it is possible to clean the dirt on the conveyance path using both surfaces of the medium by inverting the medium. Therefore, according to the cleaning method for the printing apparatus related to Appendix 19, it is possible to clean the conveyance path without degrading the usability of the printing apparatus or increasing the size of the printing apparatus.

What is claimed is:

1. A printing apparatus comprising:
a conveyance path through which a medium is conveyed;
a conveyance roller configured to convey the medium along the conveyance path;
a support portion configured to support the medium conveyed through the conveyance path;
a printhead configured to perform printing on the medium by ejecting droplets onto the medium supported by the support portion;
a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction; and
a controller configured to control drive of the conveyance roller, wherein
the controller executes, based on reception of an execution of a cleaning mode of cleaning the conveyance path, first control of causing the medium to reach at least the support portion by causing the conveyance roller to convey the medium in the forward direction and then executes second control of merging the medium with the conveyance path via the inverting path by causing the conveyance roller to convey the medium in the backward direction, and causing the conveyance roller to convey the medium in the forward direction.

2. The printing apparatus according to claim 1, wherein
the controller repeatedly executes the second control.

3. The printing apparatus according to claim 1, further comprising
a sensor configured to detect dirt on the medium, wherein
when the controller executes the second control, the controller repeatedly executes the second control based on a result of detection, by the sensor, of dirt on a surface of the medium at an opposite side to the support portion of the medium.

4. The printing apparatus according to claim 1, wherein
the controller causes the conveyance roller to perform intermittent conveyance of the medium in at least one of the first control and the second control.

5. The printing apparatus according to claim 4, wherein
the controller causes the conveyance roller to change a conveyance speed of the medium every intermittence of the intermittent conveyance.

6. The printing apparatus according to claim 4, wherein
the controller causes the conveyance roller to change a conveyance distance of the medium every intermittence of the intermittent conveyance.

7. The printing apparatus according to claim 4, wherein
the controller is configured to change stop time of the medium in the intermittent conveyance.

8. The printing apparatus according to claim 1, wherein
the controller causes the conveyance roller to perform reciprocal conveyance of the medium in at least one of the first control and the second control.

9. The printing apparatus according to claim 8, wherein
the controller is configured to change a conveyance distance of the medium and a conveyance speed of the medium in the reciprocal conveyance.

10. The printing apparatus according to claim 1, wherein
in at least one of the first control and the second control, the controller causes the printhead to eject the droplets to thereby print a pattern with the droplets on the medium.

11. A printing apparatus comprising:
a conveyance path through which a medium is conveyed;
a conveyance roller configured to convey the medium along the conveyance path;
a support portion configured to support the medium conveyed through the conveyance path;
a printhead configured to perform printing on the medium by ejecting droplets onto the medium supported by the support portion; and
a controller configured to control drive of the conveyance roller, wherein
the controller causes the conveyance roller to perform intermittent conveyance of the medium in a direction from the conveyance roller toward the printhead on the conveyance path based on reception of an execution of a cleaning mode of cleaning the conveyance path.

12. A printing apparatus comprising:
a conveyance path through which a medium is conveyed;
a conveyance roller configured to convey the medium along the conveyance path;
a support portion configured to support the medium conveyed through the conveyance path;
a printhead configured to perform printing on the medium by ejecting droplets onto the medium supported by the support portion; and
a controller configured to control drive of the conveyance roller and the printhead, wherein
the controller causes, based on reception of an execution of a cleaning mode of cleaning the conveyance path, the conveyance roller to convey the medium in a direction from the conveyance roller toward the printhead on the conveyance path, and causes the printhead to eject the droplets to thereby print a pattern with the droplets on the medium.

13. The printing apparatus according to claim 11, wherein
the controller causes, based on reception of an execution of a cleaning mode of cleaning the conveyance path, the conveyance roller to convey the medium in a forward direction from the conveyance roller toward the printhead in the conveyance path a plurality of times with conveyance in a backward direction opposite to the forward direction interposed therebetween.

14. A cleaning method for a printing apparatus including
a conveyance path through which a medium is conveyed,
a conveyance roller configured to convey the medium along the conveyance path,
a support portion configured to support the medium conveyed through the conveyance path,
a printhead configured to perform printing on the medium by ejecting droplets onto the medium supported by the support portion, and
a inverting path that branches from the conveyance path at a position at a backward direction side of the conveyance roller, inverts the medium conveyed in the backward direction, and then merges the medium with the conveyance path, defining a direction from the conveyance roller toward the printhead on the conveyance path as a forward direction, and a direction opposite to the forward direction as the backward direction, the method comprising
causing the medium to reach at least the support portion by conveying the medium in the forward direction and then merging the medium with the conveyance path via the inverting path by causing the conveyance roller to convey the medium in the backward direction, and causing the conveyance roller to convey the medium in the forward direction.
